(19) United States
(12) Patent Application Publication
(10) Pub. No.: US 2013/0206239 A1
(43) Pub. Date: Aug. 15, 2013

(54) Valve assembly

(71) Applicants: Oyvind Stokka, Sandnes (NO); Magnar Tveiten, Sandnes (NO); Ole Sevheim, Satvanger (NO); Erling Kleppa, Jorpeland (NO)

(72) Inventors: Oyvind Stokka, Sandnes (NO); Magnar Tveiten, Sandnes (NO); Ole Sevheim, Satvanger (NO); Erling Kleppa, Jorpeland (NO)

(73) Assignee: Petroleum Technology Technology Company AS

(21) Appl. No.: 13/805,343

(22) PCT Filed: Jun. 14, 2011
(86) PCT No.: PCT/NO2011/000171

§ 371 Date: Feb. 13, 2013

(30) Foreign Application Priority Data
Jun. 28, 2010 (NO) 20100933

(51) Int. Cl. F16K 13/00

(52) U.S. Cl. CPC F16K 13/00
USPC 137/1; 251/366

(57) ABSTRACT

The present invention regards a valve assembly (100) for injecting fluid, preferably a liquid, into a tubing, comprising a first and a second valve sections arranged in series within at least one outer housing (10, 11), the first valve section comprises an internal bore (13) in the housing (10) and a first sealing surface (14) and a first valve element (20) arranged movable within the bore (13) with an sealing surface (25) interacting with the first sealing surface (14) of the at least one housing (10, 11) to form a metal-metal seal, and pretension means (33) keeping the first valve section in a closed position against a hydrostatic pressure independent of tubing pressure, the second valve section arranged downstream of the first valve section and comprises an internal bore (16) in the housing (11) and a second sealing surface (17) and a second valve element (26) arranged movable within the bore (16) with a sealing surface (31) interacting with the second sealing surface (17) of the at least one housing (10, 11) to form a metal-metal seal, and pretension means (34) keeping the second valve section in a closed position until there is a given pressure difference between the fluids on the two sides of the second valve element (26) where the valve assembly in closed state forms a double barrier across the valve assembly. The present invention also regards a tubing element with a valve assembly as defined and a method for operating an injection valve assembly injecting.

The present invention regards a method for operating a valve assembly during injection of a fluid into production tubing, a valve assembly and a tubular element with the valve assembly.

When operating a well, for instance for production of oil and gas there are instances when there is a need for injecting fluids, for instance chemicals, into a production tubing extending down into the well.

The production tubing is usually comprised of several connected tubular elements. To have the opportunity of injecting fluid into the fluids within the production tubing the production tubing is usually equipped with tubular elements forming a sub and or a side pocket mandrel. These tubular elements have a main passage aligned with the passage of the production tubing and have in addition a fluid passage from outside of the production tubing to the inside of the production tubing, and valve means in this passage to provide injection at desired times.

These valves can normally be operated from closed to open position by the pressure difference between the injection fluid and the production fluid. When injection is needed the injection fluid pressure is increased at the surface and the valve is opened until the injection fluid pressure is reduced again and the valve should then closed and stay closed until next time the injection fluid pressure is increased to open the valve. However there are fluctuations in the production fluid pressure in a producing well and when a fluid is injected there will also be pressure fluctuations in the production tubing, this will also influence the opening and closing of the injection valve. There is also the issue of the injection fluid being a liquid and when the valve opens there will also be a pressure drop on the injection fluid side of the valve influencing the opening and closing of the valve. This means that there is no full control of when the injection valve is in an open or closed position. The injection valve may also be leaking at intervals as the opening and closing also gives pressure fluctuations. This is a situation which is undesirable, while it is still desirable to have an injection valve system operated by pressure difference between the injection fluid and the process fluid.

An aim with the present invention is to provide a more reliable and predictable injection valve system and at the same time also provide a more secure injection valve.

This is achieved with a method and a valve assembly as defined in the attached claims.

According to the invention there is provided a valve assembly for injecting fluid into a tubing. The fluid to be injected may be a chemical injection fluid, and possibly a liquid to be introduced into a production tubing in a well. It is also possible to envisage the valve assembly to be used with other kinds of injection system, for instance injecting water in a different kind of tubing. The valve assembly comprises according to the invention a first and a second valve section. These valve sections are arranged in series between the source of the injection fluid and the fluid into which the injection fluid should be injected. The valve assembly comprises at least one outer housing. The first valve section comprises an internal bore in the housing and a first sealing surface formed by the housing and a first valve element arranged movable within the bore with an sealing surface interacting with the first sealing surface of the at least one housing to form a metal-metal seal. The first valve element is normally preset to be in a fail safe closed state. There is arranged pretension means keeping the first valve section in a closed position against a hydrostatic pressure where this system is also independent of tubing pressure. The pretension means are arranged between the first valve element and the housing. The second valve section is arranged downstream of the first valve section and comprises an internal bore in the housing and a second sealing surface formed by the housing. There is a second valve element arranged movable within the second bore with a sealing surface interacting with the second sealing surface of the at least one housing to form a metal-metal seal. There is also between the housing and the second valve element arranged pretension means keeping the second valve section in a closed position until there is a given pressure difference between the fluids on the two sides of the valve element. These fluids will normally be an injection fluid and a production fluid. Such a configuration of the valve assembly gives a valve assembly which in a closed state forms a double barrier across the valve assembly, i.e. a double barrier between the injection fluid and the production fluid in the case the system is used for injecting a fluid into a production fluid.

With a system set up accordingly as defined above, it will form a double barrier, and it will also form a system which is not leaking injection fluid as a consequence of pressure variations in the tubing fluid. When operating the system the first valve section will be activated by adding pressure to the system from a surface installation, i.e. providing additional pressure in the injection fluid. This will open the first valve section. When the first valve section is actively opened the second valve section will open and close dependent on the pressure difference between the injection fluid and the production fluid. When pressure in the injection fluid is reduced again, the first valve section will close directly. When the first valve section is in a closed state, the second valve section will not see any active pressure from the injection fluid side and therefore also be in a closed state. As the second valve section is closed the first valve section will not see the production fluid pressure and thereby not be influenced by any pressure fluctuations in the productions fluid. By this the sealing surfaces of the first valve section is also protected from the production fluid and any debris or contaminations in this fluid which may damage the sealing surfaces, as there if the second valve means are opened there is a flow of injection fluid through the valve assembly preventing the production fluid from entering the valve assembly and when the first valve section is closed the second valve section is also closed as it is inactivated by the closing of the first valve section.

By this one has a valve assembly which will not inadvertently open dependent on pressure fluctuations in the production fluid. One has a system which can indirectly actively be set in a closed state, by reducing the pressure in the injection fluid, with the assurance that it in that state will not leak injection fluid, as there is a double barrier in a closed state. It is stated that the double barrier is formed by metal-metal seals. One should here understand that there may be a metal-metal sealing surface in the instance the valve assembly at least in part is formed by a metal material. It is possible to envisage the valve assembly at least in part may be formed by a different material than a metal, as for instance a ceramic material. The metal-metal sealing surface may in such an instance be a ceramic-ceramic seal, or a ceramic-metal seal. There may also be additional sealing systems in the valve assembly, as additional gaskets or O-rings in addition to the metal-metal seal.

According to an aspect of the invention there may be at least one housing element for each valve section. This solution with a first housing with the first valve section and a second housing with the second valve section gives the possibility of installing and possibly replacing the valve sections separately. The first and second housing may be configured to be connected and form a metal-metal seal in the connection. With such a solution one has the valve assembly as one unit, the first and second housing is then actually forming a common housing, just assembled by several parts. The housing may also comprise more than two elements attached to each other. Alternatively the housing may be formed by one individual element or more than two elements put together. According to another aspect the one housing or the first and or the second housing may comprise means for connecting it to a tubing element and forming a metal-metal seal. When there are two housing and they are connected to each other the system may be formed with connection means for connecting it to a tubing element on only one of the housings or on both of the housings.

According to an aspect of the invention the valve element of the first valve section may be formed with a mainly tubular shape which is closed in one end, with openings through the wall of the tubular shape at the closed end. This tubular shape is formed by providing a bore in an element which bore is open in one end and closed in the opposite end. The bore then forms an inner space in the element, giving the tubular shape. This gives a relatively large surface whereupon the pressure from the injection-fluid may act on the valve element. The inner space and openings of the tubular shape may form the flow passage through the valve element and in closed position an outer surface of the valve element and a surface of the valve housing forms a metal-metal seal. It is also possible to envisage other forms of the first valve element.

According to another aspect the valve element of the second valve section may be formed with a tubular shape which is closed in one end, with openings through the wall of the tubular shape at the closed end, where the inner space and openings of the tubular shape forms the flow passage through the second valve element and in closed position an outer surface of the second valve element and a surface of the valve housing forms a metal-metal seal. This is a configuration which is similar to the one of the first valve section. The valve sections may be similar, but the invention should not be understood to be limited to the valve section being similar.

Such a configuration of one of or both the valve elements and the housings gives a valve section with a relatively large cross section for the flow of the fluid to be injected through the valve section, and it also gives a flow passage through the valve system which is formed with relatively few direction changes for the flow of the fluid. Such a valve section will therefore form a valve section with relatively low pressure loss through the valve section.

According to the invention the pretension of the first valve section may comprises disc springs or other pretension/tension elements capable of withstanding the hydrostatic height (pressure) of the fluid. These disc springs or other pretension/tension elements are then set to act against the hydrostatic pressure at the position of the valve assembly in the well and an additional activation pressure to keep the first valve section in a closed state. Alternative tension elements may for instance be gas filled bellow arrangement, other kinds of spring elements, or possibly magnetic arrangements. There are in a closed state of the first valve section where also the second valve section is closed, no influence from the tubing pressure on the first valve section. According to an aspect the pretension of the second valve section comprises a helical spring element. This helical spring element is set to keep the second valve section closed until the pressure in an injection fluid is higher than the pressure of the fluid within the tubing. The tubing pressure will also assist the helical spring element to keep the second valve section in a closed state. The injection fluid therefore has to overcome the production fluid pressure and the pressure from the helical spring element to open the second valve section. The pretension means may in one configuration be different but they may also be of similar kind, just set with different pretension pressures.

According to the invention there is also provided a tubing element comprising connection means for connecting it as part of a tubing, a main passage to be align with a passage in the tubing and a fluid passage from an outside of the element extending into the main passage, where this tubing element comprises a valve assembly as described above arranged in the fluid passage. The element may be a sub or a side pocket mandrel. With a sub the valve assembly are installed in the tubing element, which then forms part of for instance a production tubing on a more permanently basis than if the tubing element is a side pocket mandrel, which still may form part of a production tubing, but the valve assembly may then be formed to be retrievable or in part be retrievable so that the whole or part of the valve assembly may be retrievable and possibly interchangeable with new parts.

According to an aspect of the invention when the tubing element is a sub at least a part of the valve housing of the valve assembly may be formed by the sub. There is also the possibility to have at least a part of the housing of the valve assembly formed by the side pocket mandrel for the parts of the valve assembly which is not retrievable, when the tubing element is a side pocket mandrel.

According to an aspect of the invention there may be arranged shear out function means upstream of the valve assembly in the fluid passage. Alternatively the shear out function means may be arranged between the valve sections or even downstream of the valve sections. These shear out functions means may be a brake disc, brake pins arranged between moveable parts etc.

According to another aspect of the invention there may be arranged filter means in the fluid passage upstream of the first valve section. The filter means may be position also upstream of shear out function means, and or possibly positioned between the two valve sections. The filter means and the fluid passage may be configured in a manner such that the filter means may be removed from the fluid passage. This may be done by having a dead end passage section connected to the fluid passage, wherein the filter means may be moved into when it is necessary to remove it from the fluid passage. One may have a similar system for the shear out function means.

According to one aspect of the invention the fluid passage in the element is configured such that is comprises a first bore extending from the outside and a distance within the structure of the element and a second bore extending from the outside and a distance within the structure of the element to an opening to the main passage of the tubing element, and a connection bore from an inner section of the first bore to a position in the second bore close to the opening to the outside, which opening is closed by a sealing element. According to an embodiment the first bore and the second bore may be mainly parallel and possibly also extending mainly parallel to the main passage of the tubing element or at an angle with the main passage. In another embodiment the first and second bore are arranged at an angle other than parallel, there may also be a third bore parallel to one or both or with another direction, forming part of the fluid passage. The main issue is to provide a fluid passage from the outside to the main passage through the tubing element, and having a configuration of this fluid passage which make is possible to position the valve assembly with the two valve sections and possibly the shear out function means and filter means. The opening of the fluid passage, an open opening of one of the bores, to the outside of the tubular element may be connected to a dedicated fluid line extending to the surface facility and a source of injection fluid and pumping facilities to achieve the necessary pressure at the valve assembly to operate the injection of the fluid into the tubular element. This will be a typical configuration if the valve assembly is used for injection of a chemical liquid. In another embodiment this opening may be open to an annulus around the tubular element.

According to another aspect the shear out function means may be arranged within the first bore, and the first and second valve section may be arranged within the second bore. The first bore may in such an embodiment extend beyond the connection bore between the first and second bore, thereby forming a dead end passage. The shear out function means may as they are sheared out by a given pressure in the injection fluid, drop or be moved into this dead end passage section, and thereby be moved out of the fluid passage as such. This dead end passage may be configured to both hold the shear out function means and also eventually the filter means if it is necessary to remove this from the fluid passage.

According to the invention there is also provided a method for operating an injection valve assembly in relation to production tubing. The method comprises the steps of positioning a valve assembly in a fluid passage extending from the annulus to a main passage in the tubing, providing the valve assembly with pretension means for keeping the valve assembly closed against hydrostatic forces at location for positioning of the valve assembly, providing additional pressure in the operating fluid to open the valve assembly for injection.

According to an aspect of the method when the valve assembly comprises two valve sections arranged in series in the fluid passage, the method may comprise providing a pressure in the operating fluid or with other words the injection fluid, to open the first valve section against a pretension means arranged in the first valve section and by this activating the second valve section arranged downstream of the first valve section in the fluid passage then providing a second pressure acting against the tubing pressure and pretension means in the second valve section to open the second valve section and inject a fluid into the tubing. Where when the pressure in the injection fluid is released the first valve section will close and thereby inactivate the second valve section, which then will be in a closed state.

According to yet another aspect of the method when the valve assembly comprises a shear out function means upstream of the first valve section, the method may comprise the steps of providing a pressure in the operating fluid to shear out the shear out function means before opening and or activating the rest of the valve assembly. Such a system may be used to control which valve assemblies to activate when there are positioned several valve assemblies along a production tubing. By having the shear out function means shear out at different pressure intervals one may activate some but not all.

The present invention will now be explained with reference to the attached drawings, where;

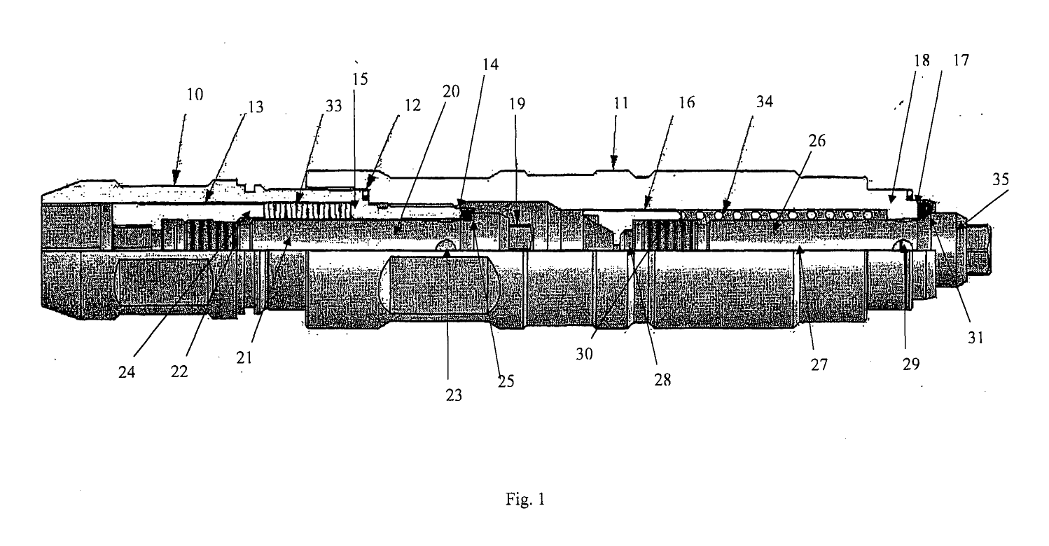

FIG. 1 shows a partly cross section of a valve assembly according to the invention,

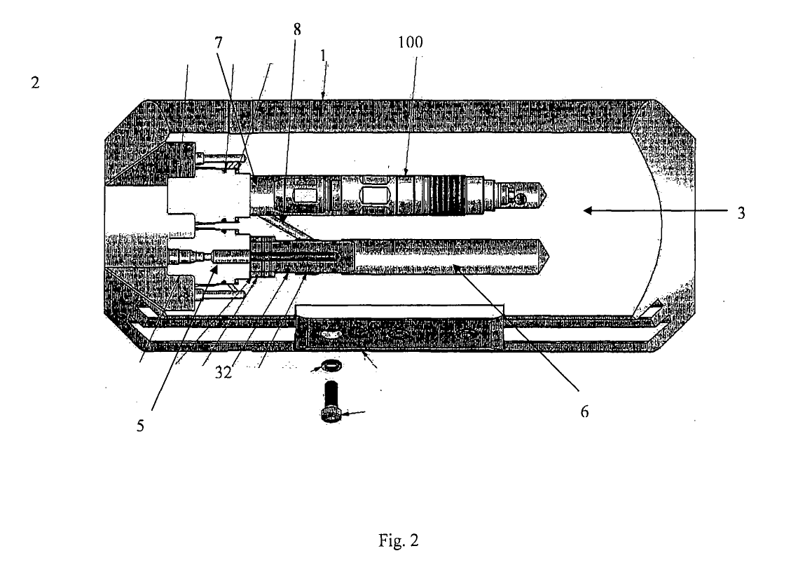

FIG. 2 shows a partly cross section of a tubing element with a valve assembly according to FIG. 1, and

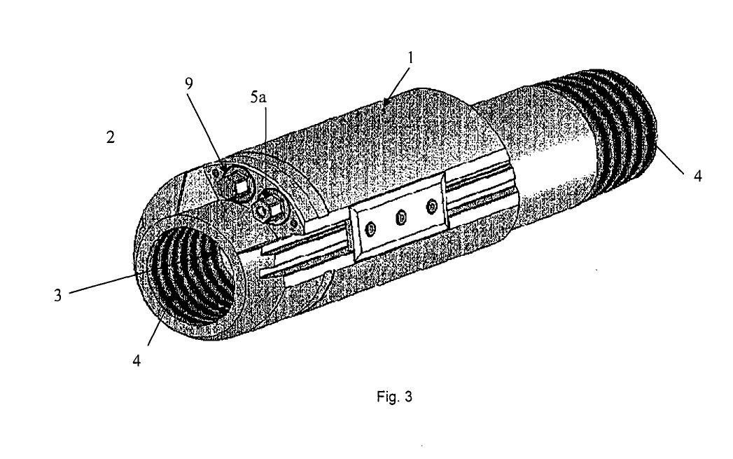

FIG. 3 shows an elevated sketch of a tubing element.

One embodiment of the valve assembly with a first valve section and a second valve section according to the invention is shown in FIG. 1. The housing of this valve assembly is divided into two parts, a first valve housing 10 and a second valve housing 11, connected with connection means 12 forming a metal-metal seal between the two valve housings 10, 11. The first and second valve section is arranged in each valve housing part, thereby forming separable units. The first housing 10 comprises a first internal bore 13 extending in a longitudinal direction of the housing 10 and forming a through going opening, and a first sealing surface 14 and a first shoulder 15. Within the internal bore 13 there is arranged a movable first valve element 20, movable in the longitudinal direction of the internal bore 13. The first valve element 20 has in this embodiment a tubular shape formed by an internal bore 21 which is open in one end 22 and which is closed in the opposite end 19. Close to the closed end 19 there are arranged openings 23 in the side wall of the valve element 20 and a sealing surface 25 on an outer surface of the valve element 20. The valve element 20 also comprises a flange part 24. The pretension means 33, in the form a disc springs in this embodiment, are arranged between the flange part 24 and the shoulder 15 and is pressing the valve element 20 to a closed state where the sealing surface 25 of the valve element 20 interact with the sealing surface 14 of the first housing to form a metal-metal seal.

Downstream of the first valve section is the second valve section arranged in a second valve housing 11. The second valve housing 11 also comprises an second internal bore 16 extending through the housing, a second shoulder 18 and a second sealing surface 17. Within the second internal bore 16 there is arranged a second valve element 26, movable in the longitudinal direction of the internal bore 16 of the second valve housing 11. The second valve element 26 comprises an internal bore 27 which is open in one end 28 and closed in the opposite end 35, giving the second valve element 26 a tubular shape. Close to the closed end 35 there are arranged openings 29 in the side wall of the valve element 26. The second valve element 26 also comprises a sealing surface 31 interacting with the second sealing surface 17 of the second valve housing 11 to form a closed state and a metal to metal seal. The second valve element 26 also comprises a flange part 30, and there is a second tension means 34 arranged between this flange part 30 and the second shoulder 18 of the second valve housing 11, to keep the valve element 26 in a closed state, by biasing the sealing surfaces 31, 17 towards each other, when the pressure difference across the valve element is lower than a set limit where the valve section will open.

In FIG. 2 the valve assembly is positioned in a tubular element according to the invention. The tubular element 1 is in this instance a sub 1. The sub has as indicated in FIG. 3 a through going opening 3 and connection means 4 to connect the sub to other tubular elements and thereby forming part of a production tubing. There is arranged a fluid passage from the outside 2 of the sub 1 to the through going opening 3. The inlet of this fluid passage on the outside is the opening 5a as indicated in FIG. 3, leading to a first bore 5 formed in the structure of the sub 1. The first bore 5 is extending for a distance into the structure. There is also a second bore 7 extending mainly parallel to the first bore 5 into the structure. The second bore is closed to the outside surroundings with a sealing cap 9 as indicated in FIG. 3. The second bore 7 opens up to the through going opening 3 of the tubular structure at the opposite end of the bore 7 compared with the end with the sealing cap 9. There is between the first bore 5 at a distance from the opening 5a made a connection bore 8 leading from the first bore 5 to the second bore 7 close to the sealing cap 9. The rest of the first bore 5 which is arranged inside or within of opening to the connection bore 8, forms a dead end passage section 6. There is in the first bore 5 arranged shear out function means 32, when these are sheared out they will fall or be pushed into the dead end passage section 6, where they are outside the fluid passage and therefore no longer blocking this passage. The valve assembly 100 with the first and second valve sections are arrange in the second bore, and there forming a double barrier between the injection fluid and the fluid within the main passage 3 of the tubular element 1.

The invention has now been explained with reference to non-limiting embodiments. A skilled person will understand that there may be made alternations and modifications to the embodiments described that are within the scope of the invention as defined in the attached claims. The housing of the valve assembly may be formed in one piece or in more than two pieces, or it may be partly formed by the structure of the tubular element. The first and second valve sections may be arranged in a same bore in the structure or in separate bores, and connected to each other or kept as separate elements etc.

1-18. (canceled)

19. Valve assembly for injecting fluid, preferably a liquid, into a tubing, comprising a first and a second valve sections arranged in series within at least one outer housing, the second valve section being arranged downstream of the first valve section, wherein the first valve section comprises an internal bore in the at least one housing and wherein the second valve section comprises an internal bore in the at least one outer housing, wherein the first valve section comprises a first sealing surface and a first valve element arranged movable within the bore with a sealing surface interacting with the first sealing surface of the at least one housing to form a metal-metal seal, and pretension means keeping the first valve section in a closed position against a hydrostatic pressure independent of tubing pressure, and wherein the second valve section comprises a second sealing surface and a second valve element arranged movable within the bore with a sealing surface interacting with the second sealing surface of the at least one housing to form a metal-metal seal, and pretension means keeping the second valve section in a closed position until there is a given pressure difference between the fluids on the two sides of the second valve element where the valve assembly in closed state forms a double barrier across the valve assembly.

20. Valve assembly according to claim 19, wherein there is at least one housing element for each valve section.

21. Valve assembly according to claim 20, wherein the first and second housing are configured to be connected and form a metal-metal seal in the connection.

22. Valve assembly according to claim 21, wherein the one or first and or second housing comprises means for connecting it to a tubing element and forming a metal-metal seal.

23. Valve assembly according to claim 22, wherein the valve element of the first valve section is formed with a tubular shape which is closed in one end, with openings through the wall of the tubular shape at the closed end, where the inner space and openings of the tubular shape forms the flow passage through the valve element and in closed position an outer surface of the valve element and a surface of the valve housing forms a metal-metal seal.

24. Valve assembly according to claim 23, wherein the valve element of the second valve section is formed with a tubular shape which is closed in one end, with openings through the wall of the tubular shape at the closed end, where the inner space and openings of the tubular shape forms the flow passage through the second valve element and in closed position an outer surface of the second valve element and a surface of the valve housing forms a metal-metal seal.

25. Valve assembly according to claim 24, wherein the pretension means of the first valve section comprises disc springs.

26. Valve assembly according to claim 25, wherein the pretension means of the second valve section comprises a helical spring element.

27. Tubing element comprising connection means for connecting it as part of a tubing, a main passage to be align with a passage in the tubing and a fluid passage from an outside of the element extending into the main passage, wherein a valve assembly according to one of the claims 1 to 8 is arranged in the fluid passage.

28. Tubing element according to claim 27, wherein the element is a sub or a side pocket mandrel.

29. Tubing element according to claim 28, wherein the tubing element is a sub and at least a part of the valve housing is formed by the sub.

30. Tubing element according to claim 29, wherein there is arranged shear out function means upstream of the valve assembly in the fluid passage.

31. Tubing element according to one of the claim 30, wherein there in the fluid passage upstream of the first valve section is arranged filter means.

32. Tubing element according to one of the preceding claim 31, wherein the fluid passage in the element is configured such that is comprises a first bore extending from the outside and a distance within the structure of the element and a second bore extending from the outside and a distance within the structure of the element to an opening to the main passage of the element, and a connection bore from an inner section of the first bore to a position in the second bore close to the opening to the outside, which opening is closed by a sealing element.

33. Tubing element according to one of the preceding claim 32, wherein the first bore and the second bore is mainly parallel, and extending mainly parallel to the main passage of the tubing element.

34. Tubing element according to one of the preceding claim 33, wherein a shear out function means are arranged within the first bore, and the first and second valve section are arranged within the second bore.

35. Method for operating an injection valve assembly comprising a first valve section and a second valve section arranged in series, the method comprising the steps of positioning the valve assembly in a fluid passage extending from an annulus to a main passage in a tubing, providing the valve assembly with pretension means for keeping the valve assembly closed against hydrostatic forces at location for positioning of the valve assembly, providing a pressure in an operating fluid to open the first valve section against a pretension means arranged in the first valve section, and providing a second pressure acting against the tubing pressure and a pretension means (34) arranged in the second valve section to open the second valve section and inject the fluid into the tubing.

36. Method according to claim 35, wherein the valve assembly comprises a shear out function means upstream of the first valve section, and the method comprises the steps of providing a pressure in the operating fluid to shear out the shear out function means before opening the rest of the valve assembly.
